(19) United States
(12) Patent Application Publication
(10) Pub. No.: US 2019/0253169 A1
(43) Pub. Date: Aug. 15, 2019

(54) UNMANNED VEHICLE, APPARATUS FOR SUPPORTING TIME SYNCHRONIZATION BETWEEN UNMANNED VEHICLES AND METHOD FOR THE SAME

(71) Applicant: ELECTRONICS AND TELECOMMUNICATIONS RESEARCH INSTITUTE, Daejeon (KR)

(72) Inventors: Young-Mok HA, Daejeon (KR); Moon-Sub SONG, Daejeon (KR)

(21) Appl. No.: 16/251,637

(22) Filed: Jan. 18, 2019

(30) Foreign Application Priority Data
Feb. 9, 2018 (KR) 10-2018-0016374

(51) Int. Cl. H04J 3/06; H04W 56/00; B64C 39/02

(52) U.S. Cl. CPC H04J 3/0667; H04J 3/0682; H04J 3/0676; B64C 2201/12; H04W 56/004; B64C 39/024; H04W 56/002

(57) ABSTRACT

Disclosed herein is an apparatus for supporting time synchronization between unmanned vehicles, which includes a time synchronization message generation unit for generating a first time synchronization message, including information about a reference time base used to synchronize time of one or more unmanned vehicles or one or more boards within each unmanned vehicle; a communication unit for sending the first time synchronization message to the unmanned vehicle, the boards, or an additional apparatus for supporting time synchronization, connected over a network, and receiving a second time synchronization message from the unmanned vehicles or the additional apparatus for supporting time synchronization; and a time synchronization unit for determining an optimal time base using the first and second synchronization messages and synchronizing an internal time base with the unmanned vehicles, the boards, or the additional apparatus for supporting time synchronization using the optimal time base.

### CROSS REFERENCE TO RELATED APPLICATION

This application claims the benefit of Korean Patent Application No. 10-2018-0016374, filed Feb. 9, 2018, which is hereby incorporated by reference in its entirety into this application.

### BACKGROUND OF THE INVENTION

### 1. Technical Field

The present invention relates to unmanned vehicles, an apparatus for supporting time synchronization between unmanned vehicles, and a method for the same.

### 2. Description of the Related Art

Recently, with the development of technology for unmanned vehicles, the demand for unmanned vehicles has increased. For example, driverless cars, unmanned air vehicles, drones, and the like are included in the category of unmanned vehicles. Here, an unmanned vehicle may send and receive information to and from other surrounding unmanned vehicles by communicating therewith. Here, in order to correctly send and receive information and to combine and use the sent and received information, it is necessary to synchronize the time between respective unmanned vehicles. If the time is not synchronized between the unmanned vehicles, an additional process for verifying delivered messages or information is required, which wastes time and effort.

The above-described information about the related art has been retained by the inventors for the purpose of developing the present invention or was obtained during the process of developing the present invention. Also, it should be appreciated that this information did not necessarily belong to the public domain before the patent filing date of the present invention.

In connection with this, Korean Patent No. 10-1685548 discloses a technology related to “Method for controlling fleet of drones”.

### SUMMARY OF THE INVENTION

An object of the present invention is to provide unmanned vehicles, an apparatus for supporting time synchronization between unmanned vehicles, and a method for the same.

Another object of the present invention is to provide an unmanned vehicle that synchronizes time with other unmanned vehicles through communication therewith and a method for time synchronization therebetween.

A further object of the present invention is to provide an apparatus for synchronizing time between multiple boards within a single unmanned vehicle or between multiple components in a single board and a method for the same.

An embodiment of the present invention provides an apparatus for supporting time synchronization between unmanned vehicles, the apparatus including a time synchronization message generation unit for generating a first time synchronization message that includes information about a reference time base used to synchronize the time of one or more unmanned vehicles or one or more boards within each of the unmanned vehicles; a communication unit for sending the first time synchronization message to the unmanned vehicles, the one or more boards within each of the unmanned vehicles, or an additional apparatus for supporting time synchronization, connected over a network, and receiving a second time synchronization message from the unmanned vehicles or the additional apparatus for supporting time synchronization; and a time synchronization unit for determining an optimal time base using the first and second time synchronization messages and synchronizing an internal time base with the unmanned vehicles, the boards, or the additional apparatus for supporting time synchronization using the optimal time base.

Here, the time synchronization unit may synchronize the time bases of components of each of the boards.

Here, when the second time synchronization message is received from the additional apparatus for supporting time synchronization, the time synchronization unit may select the reference time base of an apparatus for supporting time synchronization that functions as a master apparatus as the optimal time base.

Here, the communication unit may add a transmission timestamp and a reception timestamp for sent and received messages.

Here, the time synchronization unit may calibrate the internal time base in consideration of a network delay.

Here, the time synchronization unit may calibrate the internal time base in consideration of clock skew, which is a difference of a time change rate in a device from an absolute time change rate.

Here, the communication unit may send and receive the first and second time synchronization messages by including the first time synchronization message and the second time synchronization message in a payload of a message according to a communication protocol corresponding to the network.

Another embodiment of the present invention provides an unmanned vehicle, which includes a time synchronization message generation unit for generating a first time synchronization message that includes information about an internal time base used to synchronize time with one or more boards in the unmanned vehicle or an additional unmanned vehicle; a communication unit for sending the first time synchronization message to the boards connected over a network, the additional unmanned vehicle connected over a network, or a time synchronization support apparatus connected over a network and receiving a second time synchronization message therefrom; and a time synchronization unit for determining an optimal time base using the first and second time synchronization messages and synchronizing the internal time base with the boards, the additional unmanned vehicle, or the time synchronization support apparatus using the optimal time base.

Here, the time synchronization unit may synchronize the time bases of components of each of the boards.

Here, when the second time synchronization message is received from the time synchronization support apparatus, the time synchronization unit may select the reference time base of a time synchronization support apparatus that functions as a master apparatus as the optimal time base.

Here, the communication unit may add a transmission timestamp and a reception timestamp for sent and received messages.

Here, the time synchronization unit may calibrate the internal time base in consideration of a network delay.

Here, the time synchronization unit may calibrate the internal time base in consideration of clock skew, which is a difference of a time change rate in a device from an absolute time change rate.

Here, the communication unit may send and receive the first and second time synchronization messages by including the first time synchronization message and the second time synchronization message in a payload of a message according to a communication protocol corresponding to the network.

A further embodiment of the present invention provides a method for supporting time synchronization between unmanned vehicles, in which a time synchronization support apparatus is used, the method including generating a first time synchronization message that includes information about a reference time base used to synchronize the time of one or more unmanned vehicles or one or more boards within each of the unmanned vehicles; sending the first time synchronization message to the unmanned vehicles connected over a network, the one or more boards within each of the unmanned vehicles, or an additional time synchronization support apparatus connected over a network; receiving a second time synchronization message from the unmanned vehicles or the additional time synchronization support apparatus; determining an optimal time base using the first time synchronization message and the second time synchronization message; and synchronizing an internal time base with the unmanned vehicles, the boards, or the additional time synchronization support apparatus using the optimal time base.

Here, synchronizing the internal time base may include synchronizing the time bases of components of each of the boards.

Here, determining the optimal time base may be configured to select the reference time base of a time synchronization support apparatus that functions as a master apparatus as the optimal time base when the second time synchronization message is received from the additional time synchronization support apparatus.

Here, sending the first time synchronization message may be configured to add a transmission timestamp for a message to be sent, and receiving the second time synchronization message may be configured to add a reception timestamp for a received message.

Here, synchronizing the internal time base may further include calibrating the internal time base in consideration of a network delay.

Here, synchronizing the internal time base may further include calibrating the internal time base in consideration of clock skew, which is a difference of a time change rate in a device from an absolute time change rate.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a system for supporting time synchronization between unmanned vehicles according to an embodiment of the present invention;

FIG. 2 is a block diagram that shows an example of the apparatus for supporting time synchronization between unmanned vehicles illustrated in FIG. 1;

FIG. 3 is a block diagram that shows an example of the unmanned vehicle illustrated in FIG. 1;

FIG. 4 is a view that shows engines used to synchronize time according to an embodiment of the present invention;

FIG. 5 is a view that shows an example of a time synchronization message according to an embodiment of the present invention;

FIG. 6 is a view that shows a path along which a time synchronization message is delivered according to an embodiment of the present invention; and

FIG. 7 is a flowchart that shows a method for synchronizing time between unmanned vehicles according to an embodiment of the present invention.

### DESCRIPTION OF THE PREFERRED EMBODIMENTS

Because the present invention may be variously changed and may have various embodiments, specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, and all or some of the embodiments may be selectively combined and configured, so that the embodiments may be modified in various ways. It will be understood that, although the terms “first,” “second,” etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

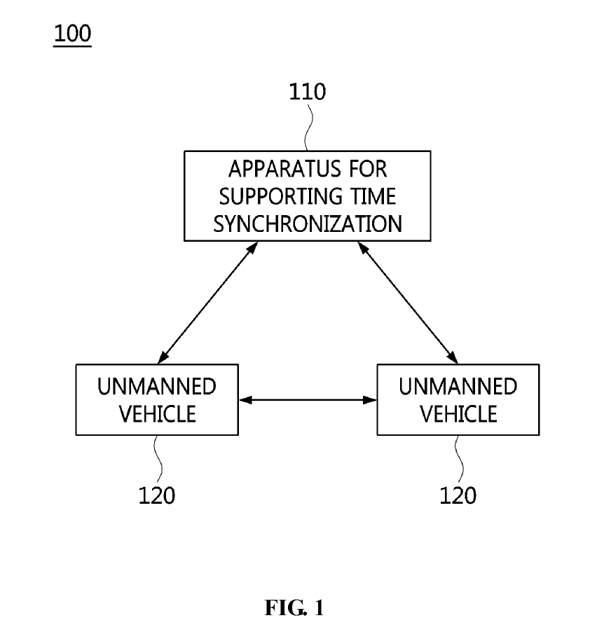

FIG. 1 is a view that shows the configuration of a system 100 for supporting time synchronization between unmanned vehicles according to an embodiment of the present invention.

Referring to FIG. 1, in the system 100 for supporting time synchronization between unmanned vehicles according to an embodiment of the present invention, an apparatus 110 for supporting time synchronization between unmanned vehicles is connected with one or more unmanned vehicles 120.

The apparatus 110 for supporting time synchronization between unmanned vehicles according to an embodiment of the present invention generates a time synchronization message that includes information about a reference time base used to synchronize time of one or more unmanned vehicles 120, sends the time synchronization message to the unmanned vehicles 120 connected over a network or to an additional apparatus 110 for supporting time synchronization, which is connected over a network, receives a time synchronization message from the unmanned vehicles 120 or the additional apparatus 110 for supporting time synchronization, and synchronizes a time base using the sent time synchronization message and the received time synchronization message. That is, synchronizing time between unmanned vehicles may include defining, generating, and exchanging messages required for time synchronization.

Here, time synchronization between unmanned vehicles means that hardware components included in a group of unmanned vehicles synchronize time therebetween. The group of unmanned vehicles may include one or more unmanned vehicles 120 and one or more apparatuses 110 for supporting time synchronization between unmanned vehicles.

Here, the term ‘time’ may indicate a physical or logical time value that represents the time kept by each node (each unmanned vehicle or each apparatus for supporting time synchronization between unmanned vehicles), and the time value may be represented using a register or memory variable, the value of which increases or decreases in response to a periodic electrical signal if there is no external manipulation. Here, external manipulation is behavior of modifying a register or memory variable for representing time with a specific purpose other than showing the lapse of time, for example, in order to modify the time value when it is necessary to synchronize time.

Here, time synchronization between the unmanned vehicles 120 may include time synchronization between multiple nodes, time synchronization between multiple boards within a single node, and time synchronization between multiple components in a single board. The time synchronization between multiple components in a single board may include synchronization between processors, cores in the processor, and registers or memory variables.

Here, communication between the unmanned vehicles 120 and communication between the apparatus 110 for supporting time synchronization and the unmanned vehicles 120 may be performed through wired network communication or wireless network communication. Here, “wired network communication” refers to a means of exchanging information using physical lines, and may include wired serial communication, wired parallel communication, wired bus communication, and the like. Also, “wireless network communication” refers to a means of exchanging information without physical lines, and may include serial communication, parallel communication, Bluetooth, and the like.

Also, communication between multiple boards within a single unmanned vehicle 120 may be performed through wired network communication or wireless network communication. Here, “wired network communication” refers to a means of exchanging information using physical lines, and may include wired serial communication, wired parallel communication, wired bus communication, and the like. Also, “wireless network communication” refers to a means of exchanging information without physical lines, and may include serial communication, parallel communication, Bluetooth, and the like.

When two or more apparatuses 110 for supporting time synchronization are included in a single system 100 for supporting time synchronization between unmanned vehicles, one of the apparatuses 110 may operate as a master apparatus for supporting time synchronization, and the remaining apparatuses 110 may operate as slave apparatuses for supporting time synchronization. Then, based on information about the reference time base of the master apparatus for supporting time synchronization, time may be synchronized between the apparatuses included in the system 100 for supporting time synchronization between unmanned vehicles.

The unmanned vehicle 120 is a vehicle that operates in the state in which no person rides therein or controls the same.

For example, the unmanned vehicle 120 may include a multi-copter, a driverless car, a drone, and the like.

Recently, with the development of unmanned vehicles, it is required to exchange information therebetween. However, if messages for the exchange of information are sent and received between unmanned vehicles in the state in which time is not synchronized therebetween, the messages may be processed as invalid ones. In order to prevent this problem, an additional verification step is required, which imposes a high computational load. However, when time is synchronized between unmanned vehicles according to an embodiment of the present invention, the validity of the time related to messages sent and received between unmanned vehicles is ensured, whereby information may be efficiently exchanged without the need to perform additional verification.

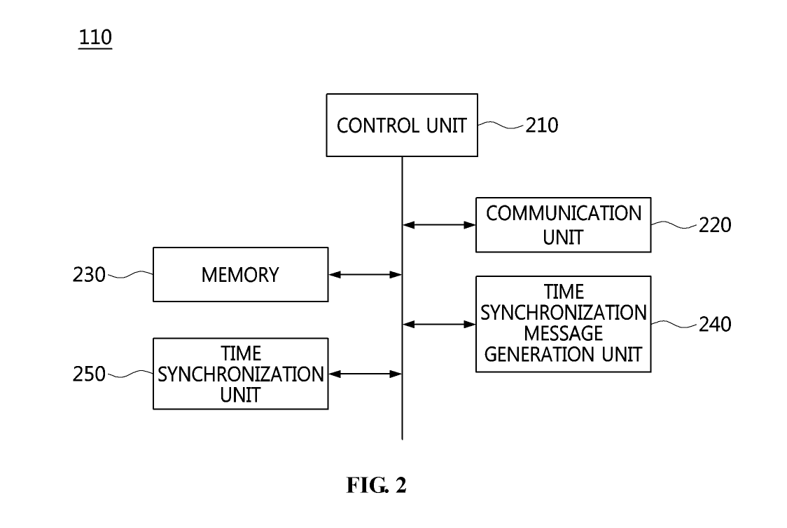

FIG. 2 is a block diagram that shows an example of the apparatus 110 for supporting time synchronization between unmanned vehicles, illustrated in FIG. 1.

Referring to FIG. 2, the apparatus 110 for supporting time synchronization between unmanned vehicles according to an embodiment of the present invention includes a control unit 210, a communication unit 220, memory 230, a time synchronization message generation unit 240, a time synchronization unit 250, and the like.

Specifically, the control unit 210 is a kind of central processing unit, and controls the overall process of supporting time synchronization between unmanned vehicles. That is, the control unit 210 may provide various functions by controlling the communication unit 220, the memory 230, the time synchronization message generation unit 240, the time synchronization unit 250, and the like.

Here, the control unit 210 may include all kinds of devices capable of processing data, such as a processor or the like. Here, the term ‘processor’ may indicate, for example, a data-processing device embedded in hardware, which has a circuit physically structured for performing functions represented as code or instructions included in a program. Examples of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 220 provides a communication interface that is necessary to send and receive signals between the apparatus 110 for supporting time synchronization and the unmanned vehicles (120 in FIG. 1). Also, the communication unit 220 provides a communication interface that is necessary to send and receive signals to and from an additional apparatus 110 for supporting time synchronization between unmanned vehicles.

Here, the communication unit 220 may be a device including hardware and software that are necessary in order to send and receive signals, such as control signals or data signals, to and from another network device through wired/wireless connection therewith.

Here, the communication unit 220 may provide a communication interface that is necessary in order to send and receive signals between boards in the corresponding apparatus 110 for supporting time synchronization between unmanned vehicles. That is, the communication unit 120 may set a communication channel for communication between the boards.

Here, the communication unit 220 may send and receive data according to a communication protocol or a message exchange protocol, which is used to exchange information between unmanned vehicles (120 in FIG. 1). For example, the message exchange protocol may include a Micro Air Vehicle Link (MAVLink).

Here, the communication unit 220 may send a time synchronization message to the unmanned vehicles (120 in FIG. 1) or an additional apparatus 110 for supporting time synchronization, connected over a network, and may receive a time synchronization message therefrom.

Here, the communication unit 220 may add a transmission timestamp to the message to be sent when it sends the message. Also, the communication unit 220 may add a reception timestamp to a received message when it receives the message.

The memory 230 functions to temporarily or permanently store data processed by the control unit 210. Here, the memory 230 may include magnetic storage media or flash storage media, but the present invention is not limited thereto.

The time synchronization message generation unit 240 generates a time synchronization message to be used to synchronize time with the unmanned vehicles (120 in FIG. 1), one or more boards within each of the unmanned vehicles (120 in FIG. 1), or an additional apparatus 110 for supporting time synchronization.

Here, the generated time synchronization message may be used to synchronize time with the additional apparatus 110 for supporting time synchronization, the unmanned vehicles (120 in FIG. 1), or the one or more boards within each unmanned vehicle (120 in FIG. 1). Particularly, synchronization with the additional apparatus 110 for supporting time synchronization, synchronization with the unmanned vehicles (120 in FIG. 1), and synchronization with the one or more boards within each unmanned vehicle (120 in FIG. 1) may be simultaneously performed, but may be performed in an order that is preset depending on time synchronization priority. For example, time synchronization with the additional apparatus 110 for supporting time synchronization may be performed first, after which time synchronization with the unmanned vehicles (120 in FIG. 1) may be performed. Finally, time synchronization with the one or more boards within each unmanned vehicle (120 in FIG. 1) may be performed.

Here, the time synchronization message generation unit 240 may generate a time synchronization message that includes information about a reference time base. Here, the reference time base may be a time base based on which time may be synchronized with the unmanned vehicles (120 in FIG. 1).

Here, the time synchronization message generation unit 240 may generate a time synchronization message according to the message generation rule of a communication protocol or a message exchange protocol, which is used to exchange information between the unmanned vehicles 120.

Here, the time synchronization message generation unit 240 may generate a time synchronization message in which time synchronization information is included in the form of a payload in the layer above the communication protocol layer or the message exchange protocol layer.

The time synchronization unit 250 synchronizes the time base with the additional apparatus 110 for supporting time synchronization and the unmanned vehicles (120 in FIG. 1).

Here, the time synchronization unit 250 may synchronize the time base using the sent time synchronization message and the received time synchronization message.

Here, the time synchronization unit 250 may retrieve the reference time base using the sent time synchronization message and the received time synchronization message, may determine an optimal time base, and may synchronize the time base using the optimal time base. That is, the optimal time base becomes a standard time base for time synchronization in the system (100 in FIG. 1) for supporting time synchronization between unmanned vehicles.

Here, the time synchronization unit 250 may synchronize the time base by adjusting the internal time base using the difference between the internal time base and the optimal time base.

Here, the time synchronization unit 250 may select the reference time base of the apparatus for supporting time synchronization that operates as a master apparatus as the optimal time base.

Here, the time synchronization unit 250 may calibrate the time base in consideration of a network delay. Here, the network delay may be estimated by comparing the transmission timestamp with the reception timestamp, both of which are included in the time synchronization messages. That is, the time synchronization unit 250 may acquire information about the timestamps of time synchronization messages by retrieving the timestamps.

Here, the time synchronization unit 250 may take the network delay into consideration based on a differential equation pertaining to the time by which each time synchronization message is delayed.

Here, the time synchronization unit 250 may calibrate the time base in consideration of clock skew, which is a difference of a time change rate in a device from an absolute time change rate. Here, clock skew may occur due to temperature variation, a difference in voltage, or a fabrication process.

Here, the time synchronization unit 250 may take the temperature-related clock skew and voltage-related clock skew into consideration based on a difference of time change rates with regard to variations in temperature and voltage. Also, the time synchronization unit 250 may take the clock skew related to a fabrication process into consideration based on clock skew depending on fabrication process variances that were previously measured offline.

Here, the time synchronization unit 250 may synchronize the time between multiple boards in the corresponding apparatus 110 for supporting time synchronization.

Here, for each of the boards in the corresponding apparatus 110 for supporting time synchronization, the time synchronization unit 250 may synchronize the time between multiple components included in the board. Here, the time synchronization between the multiple components may be synchronization of time variables for a processor, a core, a register, memory, and the like included in a single board.

Particularly, time synchronization in a single board may be performed for a device that is capable of simultaneously sending a periodic or aperiodic electrical signal to the components of the board, such as cores, memory, and the like, or sending an electrical signal thereto as a one-time event. For example, time synchronization between cores may be performed by simultaneously initializing or modifying registers that represent time values in the respective cores using a global timer interrupt. Also, for example, time synchronization may be performed by setting variables in memory that represent logical times to the same value when an instruction or an event signal is applied.

As described above, the apparatus for supporting time synchronization between unmanned vehicles provides information about a reference time base, based on which time may be synchronized between unmanned vehicles, thereby synchronizing time between apparatuses that constitute a group of identical unmanned vehicles.

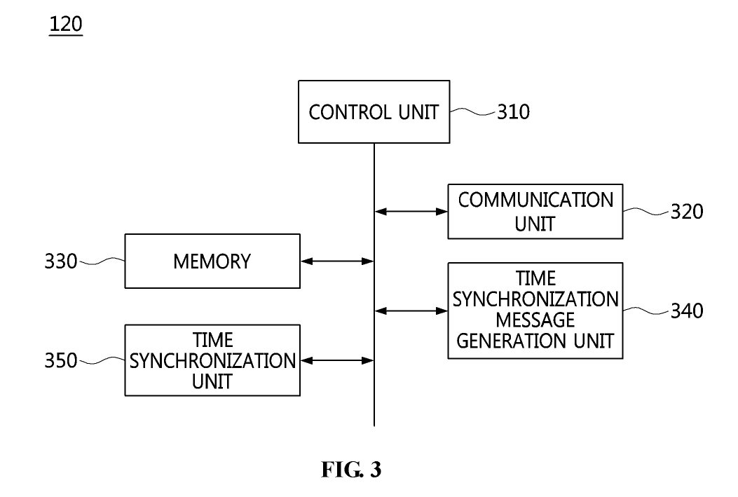

FIG. 3 is a block diagram that shows an example of the unmanned vehicle illustrated in FIG. 1.

Referring to FIG. 3, the unmanned vehicle 120 according to an embodiment of the present invention includes a control unit 310, a communication unit 320, memory 330, a time synchronization message generation unit 340, a time synchronization unit 350, and the like.

Specifically, the control unit 310 is a kind of central processing unit, and controls the overall process of supporting time synchronization between unmanned vehicles. That is, the control unit 310 may provide various functions by controlling the communication unit 320, the memory 330, the time synchronization message generation unit 340, the time synchronization unit 350, and the like.

Here, the control unit 310 may include all kinds of devices capable of processing data, such as a processor or the like. Here, the term ‘processor’ may indicate, for example, a data-processing device embedded in hardware, which has a circuit physically structured for performing functions represented as code or instructions included in a program. Examples of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 320 provides a communication interface that is necessary to send and receive signals between the unmanned vehicle 120 and the apparatus (110 in FIG. 1) for supporting time synchronization. Also, the communication unit 320 provides a communication interface that is necessary to send and receive signals to and from other unmanned vehicles 120.

Here, the communication unit 320 may be a device including hardware and software that are necessary in order to send and receive signals, such as control signals or data signals, to and from another network device through wired/wireless connection therewith.

Here, the communication unit 320 may provide a communication interface that is necessary in order to send and receive signals between boards in the corresponding unmanned vehicle 120. That is, the communication unit 320 may set a communication channel for communication between the boards in a single unmanned vehicle.

Here, the communication unit 320 may send and receive data according to a communication protocol or a message exchange protocol, which is used to exchange information between unmanned vehicles (120 in FIG. 1) or between boards within the unmanned vehicle 120. For example, the message exchange protocol may include a Micro Air Vehicle Link (MAVLink).

Here, the communication unit 320 may send a time synchronization message to the board in the corresponding unmanned vehicle 120, an additional unmanned vehicle 120, or the apparatus (110 in FIG. 1) for supporting time synchronization, connected over a network, and may receive a time synchronization message therefrom.

Here, the communication unit 320 may add a transmission timestamp to the message to be sent when it sends the message. Also, the communication unit 320 may add a reception timestamp to a received message when it receives the message.

The memory 330 functions to temporarily or permanently store data processed by the control unit 310. Here, the memory 330 may include magnetic storage media or flash storage media, but the present invention is not limited thereto.

The time synchronization message generation unit 340 generates a time synchronization message to be used to synchronize time with an additional unmanned vehicle 120, one or more boards within the corresponding unmanned vehicle, or the apparatus (110 in FIG. 1) for supporting time synchronization.

Here, the generated time synchronization message may be used to synchronize time with the additional unmanned vehicle 120, the one or more boards within the corresponding unmanned vehicle 120, and the apparatus (110 in FIG. 1) for supporting time synchronization.

Here, the time synchronization message generation unit 340 may generate a time synchronization message that includes information about an internal time base.

Here, the time synchronization message generation unit 340 may generate a time synchronization message according to the message generation rule of a communication protocol or a message exchange protocol, which is used to exchange information between the unmanned vehicles 120.

Here, the time synchronization message generation unit 340 may generate a time synchronization message in which time synchronization information is included in the form of a payload in the layer above the communication protocol layer or the message exchange protocol layer.

The time synchronization unit 350 synchronizes the internal time base with the board in the corresponding unmanned vehicle, an additional unmanned vehicle 120, and the apparatus (110 in FIG. 1) for supporting time synchronization. That is, the time synchronization unit 350 synchronizes the time base with multiple boards within the corresponding unmanned vehicle 120 as well as with the additional unmanned vehicle 120 and the apparatus (110 in FIG. 1) for supporting time synchronization.

Here, the time synchronization unit 350 may enable synchronization with the boards within the corresponding unmanned vehicle 120, synchronization with the additional unmanned vehicle 120, and synchronization with the apparatus (110 in FIG. 1) for supporting time synchronization to be simultaneously performed, but may alternatively perform time synchronization in an order that is preset depending on time synchronization priority. For example, time synchronization with the apparatus (110 in FIG. 1) for supporting time synchronization may be performed first, after which time synchronization with the additional unmanned vehicle 120 may then be performed. Finally, time synchronization with the boards within the corresponding unmanned vehicle 120 may be performed. Alternatively, for example, time synchronization with the apparatus (110 in FIG. 1) for supporting time synchronization may be performed first, and time synchronization with the boards within the corresponding unmanned vehicle 120 and time synchronization with the additional unmanned vehicle 120 may then be simultaneously performed.

Here, the time synchronization unit 350 may synchronize the time base using the sent time synchronization message and the received time synchronization message.

Here, the time synchronization unit 350 may retrieve a reference time base using the sent time synchronization message and the received time synchronization message, may determine an optimal time base, and may synchronize the time base using the optimal time base. That is, the optimal time base becomes a standard time base for time synchronization in the system (100 in FIG. 1) for supporting time synchronization between unmanned vehicles.

Here, the time synchronization unit 350 may synchronize the time base by adjusting the internal time base using the difference between the internal time base and the optimal time base.

Here, the time synchronization unit 350 may select the reference time base of the apparatus for supporting the time synchronization that functions as a master apparatus as the optimal time base.

Here, when an apparatus (110 in FIG. 1) for supporting time synchronization exists in a group of unmanned vehicles, but when the time base thereof is not included in time bases that can be retrieved, the time synchronization unit 350 may select the time base of the unmanned vehicle 120 that has the shortest communication distance from the unmanned vehicle 120 that is capable of retrieving the time base of the apparatus (110 in FIG. 1) for supporting time synchronization as the optimal time base.

Here, when an apparatus (110 in FIG. 1) for supporting time synchronization does not exist in the group of unmanned vehicles, the time synchronization unit 350 may select the time base of the unmanned vehicle 120 having a greater number of GPS reference values as a first optimal time base and select the time base of the unmanned vehicle 120 that is communicating with the greatest number of unmanned vehicles 120 as a second optimal time base.

Here, when there is no time base of a control device, among time bases that can be retrieved, when there is no additional unmanned vehicle 120 connected with the corresponding unmanned vehicle 120, and when there are multiple boards in the corresponding unmanned vehicle 120, the time synchronization unit 350 may select the time base of the board that has a greater number of GPS reference values as the first optimal time base and select the time base of the board on which a more accurate oscillator is mounted as the second optimal time base.

Here, when the time base of the unmanned vehicle 120 having a grater number of GPS reference values or the time base of the board having a greater number of GPS reference values is selected as the optimal time base, the corresponding optimal time base may be synchronized using the weighted average of the reference time values represented by GPSs.

Here, when it determines that there is an error in the time base of the unmanned vehicle 120 or the apparatus 110 for supporting time synchronization, which is selected as the optimal time base, the time synchronization unit 350 may exclude the time base of the corresponding unmanned vehicle 120 or the corresponding apparatus 110 for supporting time synchronization from the optimal time base.

Here, the time synchronization unit 350 may calibrate the time base in consideration of network delay. Here, network delay may be estimated by comparing the transmission timestamp with the reception timestamp, both of which are included in the time synchronization messages. That is, the time synchronization unit 350 may acquire information about the timestamps of time synchronization messages by retrieving the timestamps.

Here, the time synchronization unit 350 may take the network delay into consideration based on a differential equation pertaining to the time by which each time synchronization message is delayed.

Here, the time synchronization unit 350 may calibrate the time base in consideration of clock skew, which is a difference of a time change rate in a device from an absolute time change rate. Here, clock skew may occur due to temperature variation, a difference in voltage, or a fabrication process.

Here, the time synchronization unit 350 may take the temperature-related clock skew and voltage-related clock skew into consideration based on a difference of time change rates with regard to variations in temperature and voltage. Also, the time synchronization unit 350 may take the clock skew related to a fabrication process into consideration based on clock skew depending on fabrication process variances that were previously measured offline.

Here, the time synchronization unit 350 may synchronize the time between multiple boards within the corresponding unmanned vehicle 120.

Here, for each of the boards in the corresponding unmanned vehicle 120, the time synchronization unit 350 may synchronize the time between multiple components included in the board. Here, the time synchronization between the multiple components may be synchronization of time variables for a processor, a core, a register, memory, and the like included in a single board.

Particularly, time synchronization in a single board may be performed for a device that is capable of simultaneously sending a periodic or aperiodic electrical signal to the components of the board, such as cores, memory, and the like, or sending an electrical signal thereto as a one-time event. For example, time synchronization between cores may be performed by simultaneously initializing or modifying registers that represent time values in the respective cores using a global timer interrupt. Also, for example, time synchronization may be performed by setting variables in memory that represent logical times to the same value when an instruction or an event signal is applied.

Accordingly, time is synchronized between unmanned vehicles, and information may be exchanged in the state in which the unmanned vehicles maintain accurate time without the need to check the accuracy of times in messages.

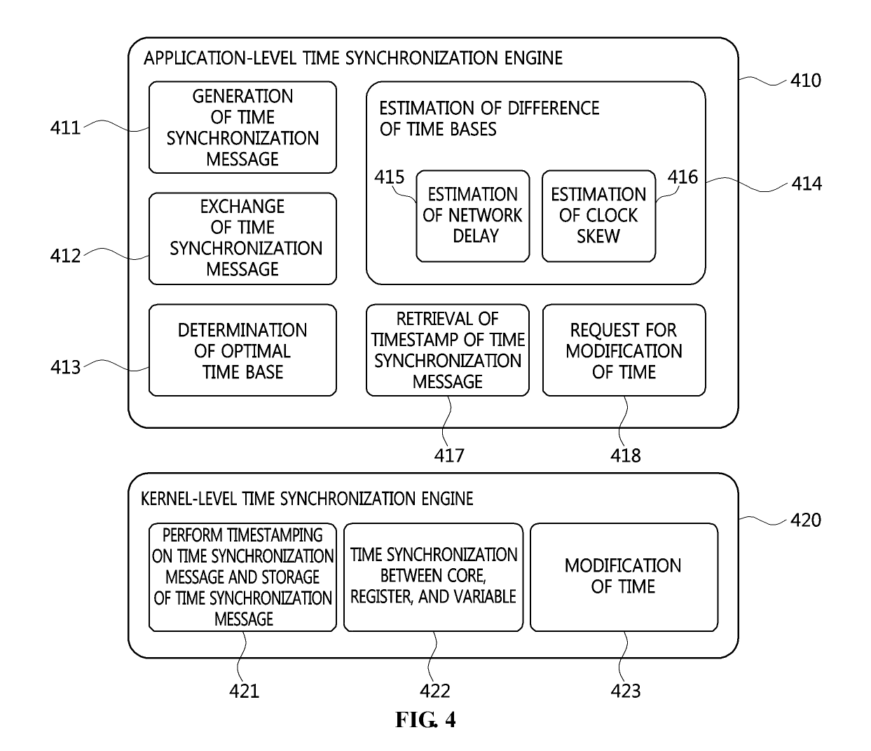

FIG. 4 is a view that shows engines that are used to synchronize time according to an embodiment of the present invention.

Referring to FIG. 4, the engines that are used for time synchronization according to an embodiment of the present invention may include an application-level time synchronization engine 410, which operates at an application level or a middleware level, and a kernel-level time synchronization engine 420, which operates at a kernel level.

Here, all of the application-level time synchronization engine 410 and the kernel-level time synchronization engine 420 are used for time synchronization processes for unmanned vehicles, excluding time synchronization between components in a single board.

Here, the application-level time synchronization engine 410 may generate a synchronization message for time synchronization (411).

Here, the application-level time synchronization engine 410 may exchange time synchronization messages with an additional unmanned vehicle (120 in FIG. 1) or with the apparatus 110 for supporting time synchronization between unmanned vehicles (412).

Here, the application-level time synchronization engine 410 may determine the optimal time base by retrieving information about time bases (413).

Here, the application-level time synchronization engine 410 may estimate and determine the difference between time bases (414). Here, the difference between time bases may be estimated and determined through estimation of network delay (415) and estimation of clock skew (416).

Here, the application-level time synchronization engine 410 may acquire timestamp information from time synchronization messages (417), and the timestamp information may be used to estimate network delay (415).

Here, the application-level time synchronization engine 410 may request modification of time based on the determined optimal time base and the difference between time bases (418).

Here, the request for modification of time (418), made by the application-level synchronization engine 410, may be processed by calling a function that is capable of modifying a register or variable representing time by receiving the estimated difference between time bases as input, rather than going through a kernel, or may be processed through a kernel by invoking a system call, whereby time may be modified.

Here, the kernel-level time synchronization engine 420 performs timestamping for sent and received time synchronization messages when the time synchronization messages are sent and received, thereby storing timestamp information in the time synchronization message (421).

Here, the kernel-level time synchronization engine 420 may synchronize time between cores, registers, and variables in a device (422).

Here, the kernel-level time synchronization engine 420 may modify time (423) in response to the request (418) from the application-level time synchronization engine 410. Here, the modification of time may be adjusting time by the difference between the time bases.

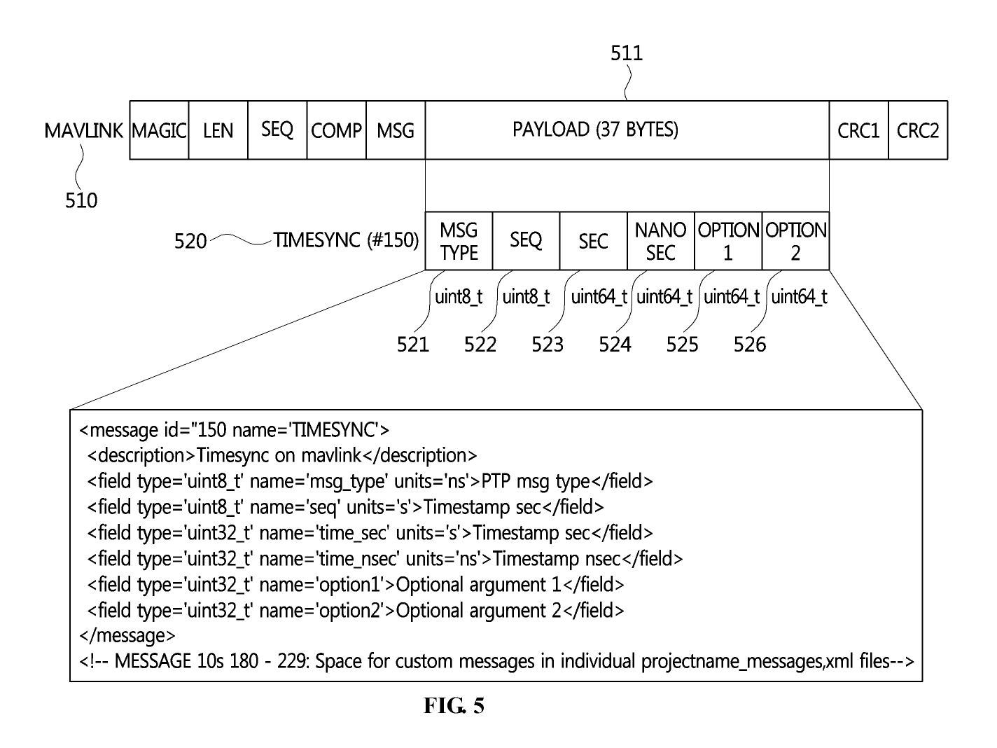

FIG. 5 is a view that shows an example of a time synchronization message according to an embodiment of the present invention.

Referring to FIG. 5, the time synchronization message 510 according to an embodiment of the present invention may be generated such that time synchronization information 520 is included in a payload 511. Here, the time synchronization message 510 in FIG. 5 is a time synchronization message defined based on MAVLink (message id: 150, name: TIMESYNC). However, even though a message is generated according to the format of another communication protocol, the payload of the message may include time synchronization information.

Here, the time synchronization information 520 included in the time synchronization message 510 may include a message type 521, a sequence 522, timestamps 523 and 524, and multiple options 525 and 526.

Here, the message type 521 or the sequence 522 may be information through which the respective time synchronization messages may be distinguished from each other.

Here, the options 525 and 526 may include the identifier of an unmanned vehicle, information about the time for which a message stays in apparatuses via which the message travels, and the like.

Here, the timestamps 523 and 524 are values acquired in such a way that the kernel-level time synchronization engine (420 in FIG. 4) measures and stores the times at which the time synchronization messages are sent and received. Here, the timestamp 523 may store timestamp information in units of seconds, and the timestamp 524 may store timestamp information in units of nanoseconds.

Here, the storage of a timestamp in the kernel-level time synchronization engine (420 in FIG. 4) and the retrieval of a timestamp in the application-level time synchronization engine (410 in FIG. 4) may be performed in a ring buffer with the same information.

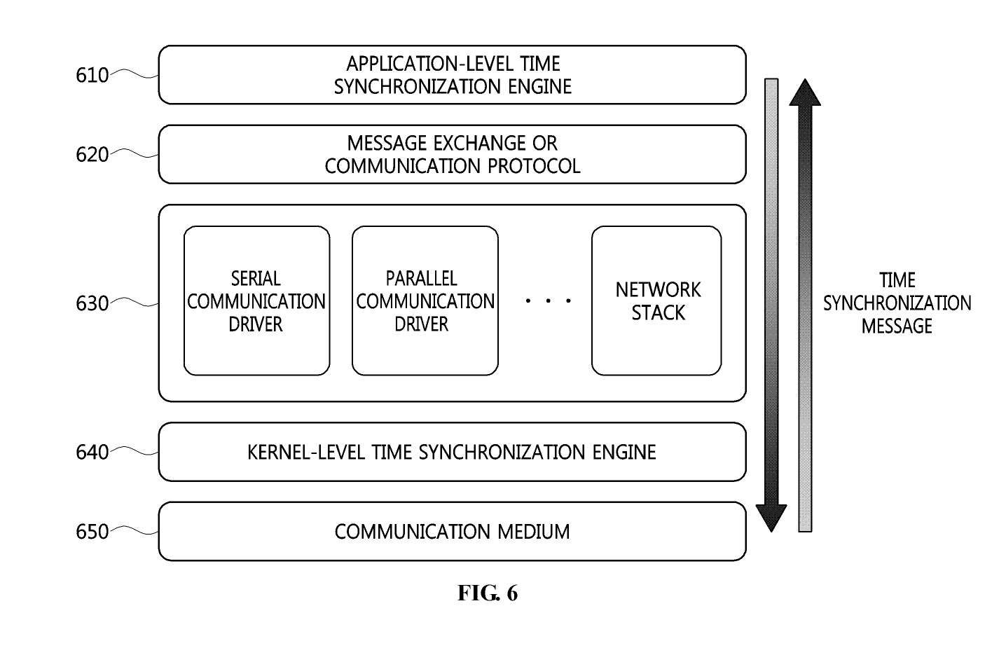

FIG. 6 is a view that shows the path along which a time synchronization message is delivered according to an embodiment of the present invention.

Referring to FIG. 6, time synchronization information according to an embodiment of the present invention is generated in the application-level time synchronization engine 610, a time synchronization message is generated by including the time synchronization information in the form of a payload according to a message exchange or communication protocol 620, and the time synchronization message is delivered to a communication medium 650 via a communication driver and a network stack 630. When the time synchronization message is delivered to the communication medium 650, timestamping for the time synchronization message may be performed in the kernel-level time synchronization engine 640.

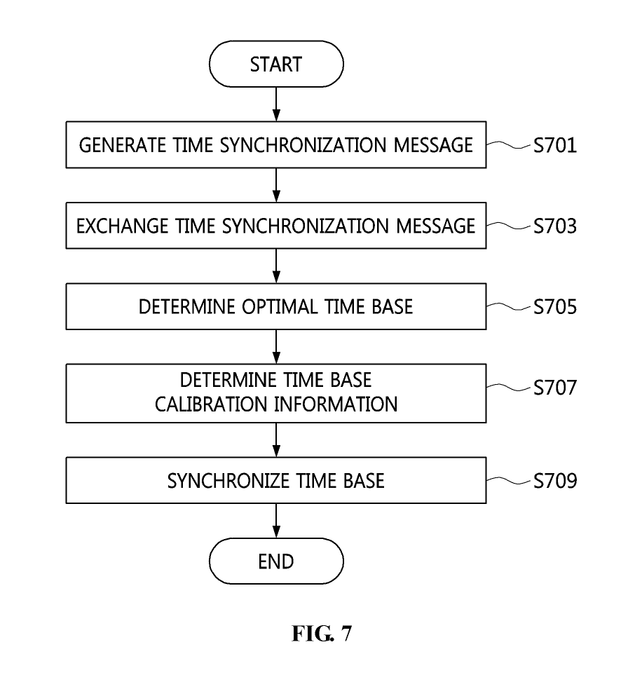

FIG. 7 is a flowchart that shows a method for synchronizing time between unmanned vehicles according to an embodiment of the present invention.

Referring to FIG. 7, in the method for synchronizing time between unmanned vehicles according to an embodiment of the present invention, a time synchronization message is generated at step S701.

Here, the time synchronization message may include information about a time base.

Also, in the method for synchronizing time between unmanned vehicles according to an embodiment of the present invention, the time synchronization message is exchanged with another unmanned vehicle (120 in FIG. 1) or another apparatus (110 in FIG. 1) for supporting time synchronization between unmanned vehicles at step S703.

Here, the time synchronization message may include a transmission timestamp and a reception timestamp.

Also, in the method for synchronizing time between unmanned vehicles according to an embodiment of the present invention, an optimal time base is determined using the time synchronization messages at step S705.

Also, in the method for synchronizing time between unmanned vehicles according to an embodiment of the present invention, time base calibration information is determined at step S707.

Here, the time base calibration information may include at least one of information for calibrating a time base in consideration of network delay and information for calibrating a time base in consideration of clock skew.

Also, in the method for synchronizing time between unmanned vehicles according to an embodiment of the present invention, the time base is synchronized using the optimal time base and the time base calibration information at step S709.

Here, time may be synchronized between multiple boards in a device.

Here, time may be synchronized between multiple components in a board.

In an alternative embodiment, among the above steps S701, S703, S705, S707 and S709, generating a time synchronization message at step S701 and exchanging time synchronization messages at step S703 may be performed in parallel.

In an alternative embodiment, among the above steps S701, S703, S705, S707 and S709, determining an optimal time base at step S705 and determining time base calibration information at step S707 may be performed in parallel.

According to the present invention, through unmanned vehicles, an apparatus for supporting time synchronization between unmanned vehicles, and a method for the same, information may be sent and received between multiple unmanned vehicles without the problem of unsynchronized time, and the reliability of the sent and received data may be guaranteed.

Also, according to the present invention, through an unmanned vehicle that synchronizes time with other unmanned vehicles by communicating therewith and a method for time synchronization, time may be synchronized between unmanned vehicles without the support of an apparatus for supporting time synchronization.

Also, according to the present invention, through an apparatus for synchronizing time between multiple boards in a single unmanned vehicle or between multiple components in a single board and a method for the same, the safe operation of an unmanned vehicle through multiplexing may be achieved.

Although specific embodiments have been described in the specification, they are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. An apparatus for supporting time synchronization between unmanned vehicles, comprising:
a time synchronization message generation unit for generating a first time synchronization message that includes information about a reference time base used to synchronize time of one or more unmanned vehicles or one or more boards within each of the unmanned vehicles;
a communication unit for sending the first time synchronization message to the unmanned vehicles, the one or more boards within each of the unmanned vehicles, or an additional apparatus for supporting time synchronization, connected over a network, and receiving a second time synchronization message from the unmanned vehicles or the additional apparatus for supporting time synchronization; and
a time synchronization unit for determining an optimal time base using the first time synchronization message and the second time synchronization message and synchronizing an internal time base with the unmanned vehicles, the boards, or the additional apparatus for supporting time synchronization using the optimal time base.

2. The apparatus of claim 1, wherein the time synchronization unit synchronizes time bases of components of each of the boards.

3. The apparatus of claim 2, wherein, when the second time synchronization message is received from the additional apparatus for supporting time synchronization, the time synchronization unit selects a reference time base of an apparatus for supporting time synchronization that functions as a master apparatus as the optimal time base.

4. The apparatus of claim 1, wherein the communication unit adds a transmission timestamp and a reception timestamp for sent and received messages.

5. The apparatus of claim 4, wherein the time synchronization unit calibrates the internal time base in consideration of a network delay.

6. The apparatus of claim 5, wherein the time synchronization unit calibrates the internal time base in consideration of clock skew, which is a difference of a time change rate in a device from an absolute time change rate.

7. The apparatus of claim 6, wherein the communication unit sends and receives the first time synchronization message and the second time synchronization message by including the first time synchronization message and the second time synchronization message in a payload of a message according to a communication protocol corresponding to the network.

8. An unmanned vehicle, comprising:
a time synchronization message generation unit for generating a first time synchronization message that includes information about an internal time base used to synchronize time with one or more boards in the unmanned vehicle or an additional unmanned vehicle;
a communication unit for sending the first time synchronization message to the boards connected over a network, the additional unmanned vehicle connected over a network, or a time synchronization support apparatus connected over a network and receiving a second time synchronization message therefrom; and
a time synchronization unit for determining an optimal time base using the first time synchronization message and the second time synchronization message and synchronizing the internal time base with the boards, the additional unmanned vehicle, or the time synchronization support apparatus using the optimal time base.

9. The unmanned vehicle of claim 8, wherein the time synchronization unit synchronizes time bases of components of each of the boards.

10. The unmanned vehicle of claim 9, wherein, when the second time synchronization message is received from the time synchronization support apparatus, the time synchronization unit selects a reference time base of a time synchronization support apparatus that functions as a master apparatus as the optimal time base.

11. The unmanned vehicle of claim 8, wherein the communication unit adds a transmission timestamp and a reception timestamp for sent and received messages.

12. The unmanned vehicle of claim 11, wherein the time synchronization unit calibrates the internal time base in consideration of a network delay.

13. The unmanned vehicle of claim 12, wherein the time synchronization unit calibrates the internal time base in consideration of clock skew, which is a difference of a time change rate in a device from an absolute time change rate.

14. The unmanned vehicle of claim 13, wherein the communication unit sends and receives the first time synchronization message and the second time synchronization message by including the first time synchronization message and the second time synchronization message in a payload of a message according to a communication protocol corresponding to the network.

15. A method for supporting time synchronization between unmanned vehicles, performed by a time synchronization support apparatus, comprising:
generating a first time synchronization message that includes information about a reference time base that is used to synchronize time of one or more unmanned vehicles or one or more boards within each of the unmanned vehicles;
sending the first time synchronization message to the unmanned vehicles connected over a network, the one or more boards within each of the unmanned vehicles, or an additional time synchronization support apparatus connected over a network;
receiving a second time synchronization message from the unmanned vehicles or the additional time synchronization support apparatus;
determining an optimal time base using the first time synchronization message and the second time synchronization message; and
synchronizing an internal time base with the unmanned vehicles, the boards, or the additional time synchronization support apparatus using the optimal time base.

16. The method of claim 15, wherein synchronizing the internal time base comprises:
synchronizing time bases of components of each of the boards.

17. The method of claim 16, wherein determining the optimal time base is configured to select a reference time base of a time synchronization support apparatus that functions as a master apparatus as the optimal time base when the second time synchronization message is received from the additional time synchronization support apparatus.

18. The method of claim 15, wherein:
sending the first time synchronization message is configured to add a transmission timestamp for a message to be sent, and
receiving the second time synchronization message is configured to add a reception timestamp for a received message.

19. The method of claim 18, wherein synchronizing the internal time base further comprises:
calibrating the internal time base in consideration of a network delay.

20. The method of claim 19, wherein synchronizing the internal time base further comprises:
calibrating the internal time base in consideration of clock skew, which is a difference of a time change rate in a device from an absolute time change rate.
